(19) United States
(12) Patent Application Publication
(10) Pub. No.: US 2007/0155387 A1
(43) Pub. Date: Jul. 5, 2007

(54) Techniques for scheduling and adaptation to combat fast fading

(76) Inventors: Qinghua Li, Sunnyvale, CA (US); Xintian E. Lin, Mountain View, CA (US)

Correspondence Address: KACVINSKY LLC;C/O INTELLEVATE, P.O. BOX 52050, MINNEAPOLIS, MN, 55402, US

(21) Appl. No.: 11/322,525

(22) Filed: Dec. 30, 2005

(51) Int. Cl. H04Q 7/20

(52) U.S. Cl. 455/441; 375/141

(57) ABSTRACT

Techniques to perform scheduling and adaptation to combat fast fading are described. An embodiment is a scheduling/adaptation scheme for a communications system for which different Orthogonal Frequency Division Multiplexing (OFDM) symbol durations and subcarrier spacing are employed for slow and fast subscribers, respectively. Other embodiments are described and claimed.

### BACKGROUND

Modern wireless communication systems may operate according to Institute of Electrical and Electronics Engineers (IEEE) standards such as the 802.11 standards for Wireless Local Area Networks (WLANs) and the 802.16 standards for Wireless Metropolitan Area Networks (WMANs). Worldwide Interoperability for Microwave Access (WiMAX) is a wireless broadband technology based on the IEEE 802.16 standard of which IEEE 802.16-2004 and the 802.16e amendment are Physical (PHY) layer specifications. In particular, IEEE 802.16 provides specifications for an air interface for fixed, portable, and mobile broadband wireless access systems. 802.16e aims to enhance the specifications to the 802.16 standard to support both fixed and mobile subscriber stations to accommodate, for example, subscriber stations moving at vehicular speeds.

### BRIEF DESCRIPTION OF THE DRAWINGS

FIG. 1 illustrates one embodiment of a wireless system.

FIG. 2 illustrates one embodiment of a wireless system node.

FIG. 3 illustrates one embodiment of an OFDMA frame.

FIG. 4 illustrates one embodiment of two OFDM signals.

FIG. 5 illustrates one embodiment of a time-frequency location of a fast subscriber.

FIG. 6 illustrates one embodiment of a time-frequency location and grouping of multiple fast subscribers.

FIG. 7 illustrates one embodiment of a pilot location.

FIG. 8 illustrates one embodiment of a logic flow.

### DETAILED DESCRIPTION

Embodiments of a system and method of Orthogonal Frequency Division Multiple Access (“OFDMA”) scheduling and adaptation to combat fast fading are described. One embodiment may comprise, for example, a scheduling/adaptation scheme for OFDMA for which different Orthogonal Frequency Division Multiplexing (“OFDM”) symbol durations are employed for slow and fast subscribers respectively. In an embodiment, slow subscribers are scheduled with smaller subcarrier spacing while the fast subscribers are grouped and scheduled with larger subcarrier spacing. The grouping of subscribers according to their speed and apportionment of subcarrier spacing accordingly may reduce inter-subcarrier interference (“ICI”) in OFDM and the corresponding OFDMA systems that support the subscribers.

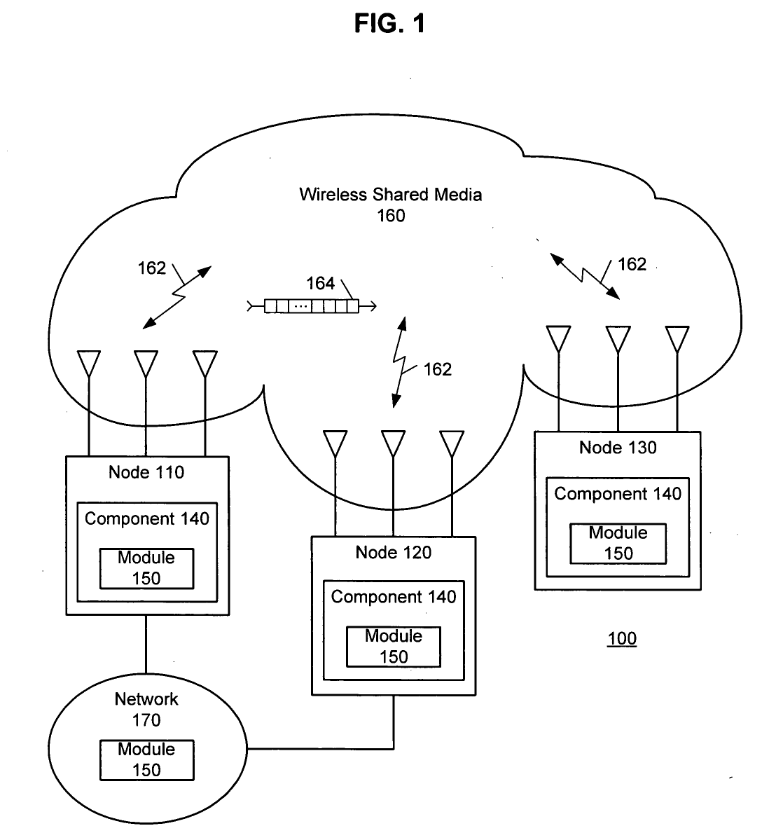

FIG. 1 illustrates an embodiment of a system. FIG. 1 illustrates a block diagram of a communications system 100. In various embodiments, the communications system 100 may comprise multiple nodes. A node generally may comprise any physical or logical entity for communicating information in the communications system 100 and may be implemented as hardware, software, or any combination thereof, as desired for a given set of design parameters or performance constraints. Although FIG. 1 may show a limited number of nodes by way of example, it can be appreciated that more or less nodes may be employed for a given implementation.

In various embodiments, a node may comprise, or be implemented as, a computer system, a computer sub-system, a computer, an appliance, a workstation, a terminal, a server, a personal computer (PC), a laptop, an ultra-laptop, a handheld computer, a personal digital assistant (PDA), a set top box (STB), a telephone, a mobile telephone, a cellular telephone, a handset, a wireless access point, a base station (BS), a subscriber station (SS), a mobile subscriber center (MSC), a radio network controller (RNC), a microprocessor, an integrated circuit such as an application specific integrated circuit (ASIC), a programmable logic device (PLD), a processor such as general purpose processor, a digital signal processor (DSP) and/or a network processor, an interface, an input/output (I/O) device (e.g., keyboard, mouse, display, printer), a router, a hub, a gateway, a bridge, a switch, a circuit, a logic gate, a register, a semiconductor device, a chip, a transistor, or any other device, machine, tool, equipment, component, or combination thereof. The embodiments are not limited in this context.

In various embodiments, a node may comprise, or be implemented as, software, a software module, an application, a program, a subroutine, an instruction set, computing code, words, values, symbols or combination thereof. A node may be implemented according to a predefined computer language, manner or syntax, for instructing a processor to perform a certain function. Examples of a computer language may include C, C++, Java, BASIC, Perl, Matlab, Pascal, Visual BASIC, assembly language, machine code, micro-code for a network processor, and so forth. The embodiments are not limited in this context.

The nodes of the communications system 100 may be arranged to communicate one or more types of information, such as media information and control information. Media information generally may refer to any data representing content meant for a user, such as image information, video information, graphical information, audio information, voice information, textual information, numerical information, alphanumeric symbols, character symbols, and so forth. Control information generally may refer to any data representing commands, instructions or control words meant for an automated system. For example, control information may be used to route media information through a system, or instruct a node to process the media information in a certain manner. The media and control information may be communicated from and to a number of different devices or networks.

In various implementations, the nodes of the communications system 100 may be arranged to segment a set of media information and control information into a series of packets. A packet generally may comprise a discrete data set having fixed or varying lengths, and may be represented in terms of bits or bytes. It can be appreciated that the described embodiments are applicable to any type of communication content or format, such as packets, cells, frames, fragments, units, and so forth.

The communications system 100 may communicate information in accordance with one or more standards, such as standards promulgated by the IEEE, the Internet Engineering Task Force (IETF), the International Telecommunications Union (ITU), and so forth. In various embodiments, for example, the communications system 100 may communicate information according to one or more IEEE 802 standards including IEEE 802.11 standards (e.g., 802.11a, b, g/h, j, n, and variants) for WLANs and/or 802.16 standards (e.g., 802.16-2004, 802.16.2-2004, 802.16e, 802.16f, and variants) for WMANs. The communications system 100 may communicate information according to one or more of the Digital Video Broadcasting Terrestrial (DVB-T) broadcasting standard and the High performance radio Local Area Network (HiperLAN) standard. The embodiments are not limited in this context.

In various embodiments, the communications system 100 may employ one or more protocols such as medium access control (MAC) protocol, Physical Layer Convergence Protocol (PLCP), Simple Network Management Protocol (SNMP), Asynchronous Transfer Mode (ATM) protocol, Frame Relay protocol, Systems Network Architecture (SNA) protocol, Transport Control Protocol (TCP), Internet Protocol (IP), TCP/IP, X.25, Hypertext Transfer Protocol (HTTP), User Datagram Protocol (UDP), and so forth.

The communications system 100 may include one or more nodes (e.g., nodes 110-130) arranged to communicate information over one or more wired and/or wireless communications media. Examples of wired communications media may include a wire, cable, printed circuit board (PCB), backplane, switch fabric, semiconductor material, twisted-pair wire, co-axial cable, fiber optics, and so forth. An example of a wireless communication media may include portions of a wireless spectrum, such as the radio-frequency (RF) spectrum. In such implementations, the nodes of the system 100 may include components and interfaces suitable for communicating information signals over the designated wireless spectrum, such as one or more transmitters, receivers, transceivers, amplifiers, filters, control logic, antennas and so forth.

The communications media may be connected to a node using an input/output (I/O) adapter. The I/O adapter may be arranged to operate with any suitable technique for controlling information signals between nodes using a desired set of communications protocols, services or operating procedures. The I/O adapter may also include the appropriate physical connectors to connect the I/O adapter with a corresponding communications medium. Examples of an I/O adapter may include a network interface, a network interface card (NIC), a line card, a disc controller, video controller, audio controller, and so forth.

In various embodiments, the communications system 100 may comprise or form part of a network, such as a WiMAX network, a broadband wireless access (BWA) network, a WLAN, a WMAN, a wireless wide area network (WWAN), a wireless personal area network (WPAN), a Code Division Multiple Access (CDMA) network, a Wide-band CDMA (WCDMA) network, a Time Division Synchronous CDMA (TD-SCDMA) network, a Time Division Multiple Access (TDMA) network, an Extended-TDMA (E-TDMA) network, a Global System for Mobile Communications (GSM) network, an Orthogonal Frequency Division Multiplexing (OFDM) network, an Orthogonal Frequency Division Multiple Access (OFDMA) network, a North American Digital Cellular (NADC) network, a Universal Mobile Telephone System (UMTS) network, a third generation (3G) network, a fourth generation (4G) network, a local area network (LAN), a wide area network (WAN), a metropolitan area network (MAN), the Internet, the World Wide Web, a cellular network, a radio network, a satellite network, and/or any other communications network configured to carry data. The embodiments are not limited in this context.

The communications system 100 may employ various modulation techniques including, for example: OFDM modulation, Quadrature Amplitude Modulation (QAM), N-state QAM (N-QAM) such as 16-QAM (four bits per symbol), 32-QAM (five bits per symbol), 64-QAM (six bits per symbol), 128-QAM (seven bits per symbol), and 256-QAM (eight bits per symbol), Differential QAM (DQAM), Binary Phase Shift Keying (BPSK) modulation, Quadrature Phase Shift Keying (QPSK) modulation, Offset QPSK (OQPSK) modulation, Differential QPSK (DQPSK), Frequency Shift Keying (FSK) modulation, Minimum Shift Keying (MSK) modulation, Gaussian MSK (GMSK) modulation, and so forth. The embodiments are not limited in this context.

In various embodiments, the communications system 100 may be arranged to schedule a scheme for OFDMA communication for multiple subscribers. More specifically, the communications system 100 may be arranged to employ different OFDM symbol durations and subcarrier spacing for slow and fast subscribers respectively. In an embodiment, the communications system 100 is arranged to schedule slow subscribers with smaller subcarrier spacing and longer OFDM symbol durations. The communications system 100 is further arranged to schedule fast subscribers with larger subcarrier spacing and shorter OFDM symbol durations. Further, the communications system 100 of an embodiment may group multiple subscribers in substantially adjacent time-frequency locations of the OFDM frame based on their speed. The grouping of subscribers according to their speed and apportionment of subcarrier spacing accordingly may reduce inter-subcarrier interference (“ICI”) in OFDM and the corresponding OFDMA systems that support the subscribers.

As used herein, the terms “slow” and “fast” may refer to the magnitude of an OFDM channel variation in time for the subscriber and the base station. The OFDM channel variation may be due to movement of the OFDM channel transmitter or receiver (e.g. the subscriber or base station), objects moving in the wireless medium, and/or wireless medium change. For example, a reflective car moving around a stationary base may change a channel of the base station. Further, the reflectivity of a fluorescent light changing in time when on may cause a channel change. Further still, motion of the subscriber or base station relative to the other may cause OFDM channel variation.

Furthermore, speed is reciprocal. The speed is the same for the both devices (e.g., subscriber and base station) for both uplink and downlink, for which the frequencies of downlink and uplink may be different. In addition to altering ODFM symbol duration, the base station and/or the subscriber (e.g., a mobile station) can adaptively adjust their transmission scheme according to the Doppler spread detected from the reverse link. For example, a subscriber may receive a downlink frame from the base station and detect an increased Doppler spread. The subscriber may in response employ more robust modulation (e.g., with a lower data rate) than that in its previous uplink transmission because the larger Doppler spread may cause degraded reception quality. Similarly, the base station can do the same thing upon detecting, for example, an increased Doppler spread. Further, the uplink and downlink between, for example, a subscriber and a base station can occupy different frequency bands.

In one embodiment, communications system 100 may include one or more wireless communication devices, such as nodes 110-130. Nodes 110-130 all may be arranged to communicate information signals using one or more wireless transmitters/receivers (“transceivers”) or radios, which may involve the use of radio frequency communication via 802.16 schemes (e.g., 802.16-2004, 802.16.2-2004, 802.16e, 802.16f, and variants) for WMANs, for example. Nodes 110-130 may communicate using the radios over wireless shared media 160 via multiple inks or channels established therein. Although FIG. 1 is shown with a limited number of nodes in a certain topology, it may be appreciated that communications system 100 may include additional or fewer nodes in any type of topology as desired for a given implementation. The embodiments are not limited in this context.

Further, nodes 110 and 120 may comprise fixed devices having wireless capabilities. A fixed device may comprise a generalized equipment set providing connectivity, management, and control of another device, such as mobile devices. Examples for nodes 110 and 120 may include a wireless access point (AP), base station or node B, router, switch, hub, gateway, media gateway, and so forth. In an embodiment, nodes 110 and 120 may also provide access to a network 170 via wired communications media. Network 170 may comprise, for example, a packet network such as the Internet, a corporate or enterprise network, a voice network such as the Public Switched Telephone Network (PSTN), among other WANs, for example. The embodiments are not limited in this context.

In one embodiment, system 100 may include node 130. Node 130 may comprise, for example, a mobile device or a fixed device having wireless capabilities. A mobile device may comprise a generalized equipment set providing connectivity to other wireless devices, such as other mobile devices or fixed devices. Examples for node 130 may include a computer, server, workstation, notebook computer, handheld computer, telephone, cellular telephone, personal digital assistant (PDA), combination cellular telephone and PDA, and so forth.

Nodes 110-130 may have one or more wireless transceivers and wireless antennas. In one embodiment, for example, nodes 110-130 may each have multiple transceivers and multiple antennas to communicate information signals over wireless shared media 160. For example, a channel 162, link, or connection may be formed using one or more frequency bands of wireless shared medium 160 for transmitting and receiving packets 164. The embodiments are not limited in this context.

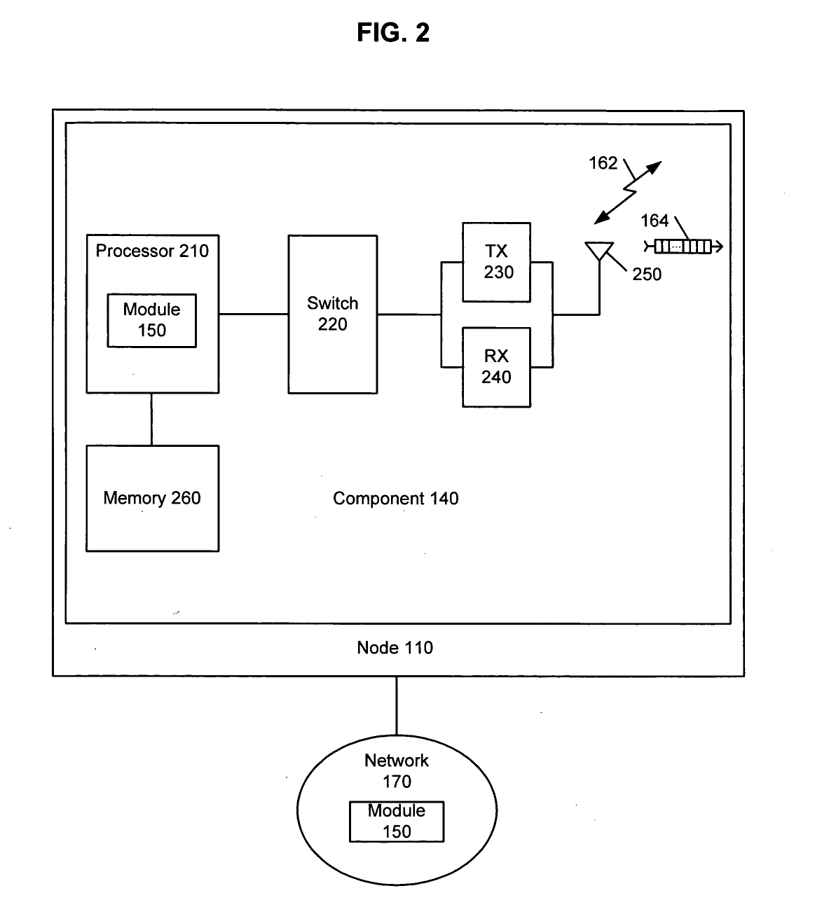

FIG. 2 more specifically illustrates node 110 of the communications system 100. As shown in FIG. 2, the node may comprise multiple elements such as component 140, module 150, processor 210, memory 260, switch 220, transmitter 230, receiver 240, and antenna 250 to communicate packets 164 over wireless shared media 160. Transmitter 230 and receiver 240 may also be collectively referred to as a transceiver. Antenna 250 may include an internal antenna, an omni-directional antenna, a monopole antenna, a dipole antenna, an end fed antenna or a circularly polarized antenna, a micro-strip antenna, a diversity antenna, a dual antenna, an antenna array, and so forth. Some elements may be implemented using, for example, one or more circuits, components, registers, processors, software subroutines, or any combination thereof. Although FIG. 2 shows a limited number of elements, it can be appreciated that additional or fewer elements may be used in node 110 as desired for a given implementation. The embodiments are not limited in this context.

As noted, in an embodiment, node 110 may include a processor 210. Processor 210 may be connected to switch 220 and/or the transceiver (e.g., transmitter 230 and receiver 240). Processor 210 may be implemented using any processor or logic device, such as a complex instruction set computer (CISC) microprocessor, a reduced instruction set computing (RISC) microprocessor, a very long instruction word (VLIW) microprocessor, a processor implementing a combination of instruction sets, or other processor device. In an embodiment, for example, processor 210 may be implemented as a general purpose processor, such as a processor made by Intel® Corporation, Santa Clara, Calif. Processor 210 may also be implemented as a dedicated processor, such as a controller, microcontroller, embedded processor, a digital signal processor (DSP), a network processor, a media processor, an input/output (I/O) processor, a media access control (MAC) processor, a radio baseband processor, a field programmable gate array (FPGA), a programmable logic device (PLD), and so forth. The embodiments are not limited in this context.

In one embodiment, processor 210 may include, or have access to, memory 260. Memory 260 may comprise any machine-readable media. Memory 260 may be implemented using any machine-readable or computer-readable media capable of storing data, including both volatile and non-volatile memory. For example, memory 260 may include read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, or any other type of media suitable for storing information. It is worthy to note that some portion or all of memory 260 may be included on the same integrated circuit as processor 210, or alternatively some portion or all of memory 260 may be disposed on an integrated circuit or other medium, for example a hard disk drive, that is external to the integrated circuit of processor 210. The embodiments are not limited in this context.

When implemented in a node of communications system 100, node 110 may be arranged to communicate information over wireless communications media between the various nodes, such as nodes 120 and 130. The information may be communicated using in the form of packets 164 over wireless shared media 160, with each packet 164 comprising media information and/or control information. The media and/or control information may be represented using, for example, multiple Orthogonal Frequency Division Multiplexing (OFDM) symbols. A packet 164 in this context may refer to any discrete set of information, including a unit, frame, cell, segment, fragment, and so forth. The packet may be of any size suitable for a given implementation. The embodiments are not limited in this context.

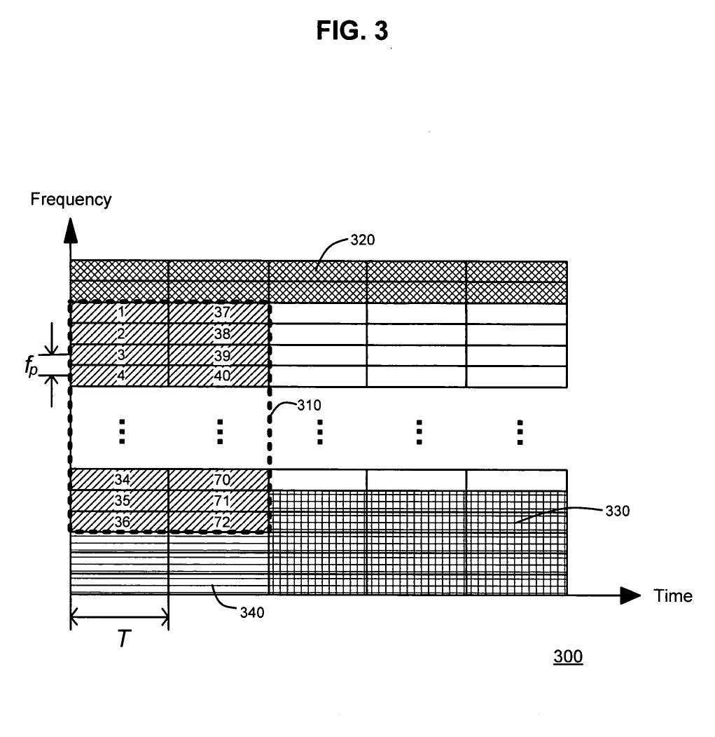

FIGS. 3-7 more specifically describe, for example, a frame structure and the arrangement of the communications system 100 and/or node 110 to generate the frame structure. For example, FIG. 3 illustrates a frame 300 according to the current IEEE 802.16e draft standard for which the subcarrier spacing is constant for all subscribers in the cell. Each block of frame 300 represents one QAM symbol carried by one subcarrier to a subscriber and different fill patterns represent the frequency-time zones assigned to multiple subscribers. For example, subscribers 310-340 have frequency-time zones assigned as illustrated. Furthermore, the frequency-time zones have been assigned to the subscribers 310-340 regardless of their speed. Said alternatively, while some subscribers may be mobile and other subscribers may be stationary, that distinction does not determine the frequency-time zone to which the subscribers' 310-340 respective symbols are assigned.

The mobility or speed of an individual subscriber (e.g., subscribers 310-340), however, may be an important feature of that subscriber. For example, high mobility, high speed, or fast fading causes ICI for OFDM and OFDMA systems that may limit their application to mobile channels and may increase the complexity of the receiver (e.g., by requiring computationally complex equalization or the like). Further, the mobile speeds of individual subscribers or groups of subscribers may be substantially different from other subscribers. Additionally, the mobile speed of a subscriber relative to a base station may range from 0 to 250 km/h as introduced above. Another such example is a subscriber traveling at vehicular speed (e.g., in an automobile, bus, taxi, train, etc) relative to a stationary base station.

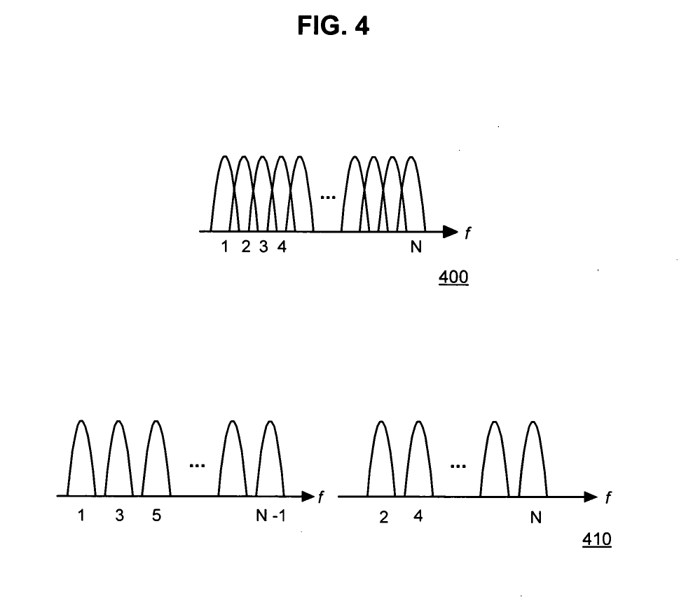

FIG. 4 illustrates two OFDM signals. For example, for a given time slot T and N adjacent subcarriers with total bandwidth Nfₚ, an OFDM symbol of N subcarriers with subcarrier spacing fₚ can be transmitted as illustrated by OFDM signal 400. Alternatively, as illustrated by OFDM signal 410, for the same frequency and time resource, two OFDM symbols with N/2 subcarriers each can be transmitted in two time slots with T/2 each for which the subcarrier spacing is 2fₚ. Ignoring guard intervals to mitigate intersymbol interference (ISI), the same amount of data and data rate can be achieved by OFDM signal 400 and by OFDM signal 410 respectively. More specifically, in general, a short OFDM symbol duration and larger subcarrier spacing reduces ICI but may simultaneously increase the overhead for additional guard intervals or larger cyclic prefix lengths. An increase in the overhead would reduce the data throughput of the communication channel. However, as OFDM signal 410 may have a shorter delay spread, the guard interval for each symbol thereof may be shortened so that OFDM signal 410 has a total guard interval duration the same as OFDM signal 400. As will be described more fully below, the OFDM signal 410 of an embodiment may benefit fast subscribers.

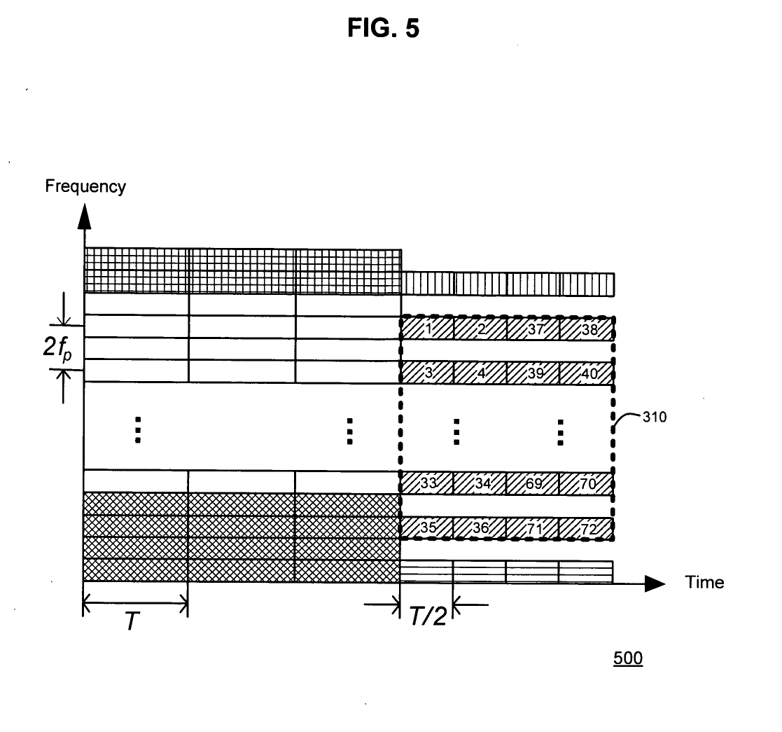

FIG. 5 illustrates the time-frequency location of a fast subscriber of an embodiment for Band AMC of 802.16e. In an embodiment, a subscriber is first categorized as to its speed. To do this, a base station detects subcarrier Doppler spread, delay spread, and/or ICI level of a mobile subscriber from its uplink signal. Based on the reciprocity between the uplink and downlink signals, the Doppler or delay spread of the uplink signals approximate the Doppler or delay spread that would be experienced by the downlink signal for each mobile subscriber. Further, since the Doppler spread is the same for the uplink signal and the downlink signal, no calibration is required for the Doppler estimation. In an embodiment, if the communications system and/or node 110 detects that, based on the above or similar metrics, a subscriber exceeds a threshold speed, or a speed relative to other subscribers, the subscriber may be designated as a fast subscriber. Further, multiple fast subscribers may be grouped together as will be discussed more fully below.

In an embodiment, once subscribers have been designated as either fast or slow, the communications system 100 and/or node 110 of an embodiment may schedule OFDM channel resources to accommodate both groups (e.g., fast and slow) of subscribers. In an embodiment, the communications system 100 and/or node 110 of an embodiment may employ two OFDM symbol durations and two subcarrier spacings (e.g., by utilizing OFDM signal 400 and OFDM signal 410 as illustrated by FIG. 4), one set assigned to the slow and fast subscribers respectively. In an embodiment, the communications system 100 and/or node 110 of an embodiment assigns shorter symbol duration and larger subcarrier spacing (e.g., OFDM signal 410) to the fast subscribers and longer symbol duration and smaller subcarrier spacing (e.g., OFDM signal 400) to the slow subscribers less prone to ICI.

In an embodiment, the communications system 100 and/or node 110 of an embodiment assigns to a fast subscriber a symbol duration that is half the duration of the slow subscriber symbol duration. For example, and as introduced above, for a given time slot T and N adjacent subcarriers with total bandwidth Nfₚ, the communications system 100 and/or node 110 of an embodiment can transmit an OFDM symbol of N subcarriers with subcarrier spacing fₚ to slow subscriber. Using the same frequency and time resource, the communications system 100 and/or node 110 of an embodiment can transmit to the fast subscriber two OFDM symbols with N/2 subcarriers each in two time slots with T/2 each, where the subcarrier spacing is 2fₚ. In an embodiment, the communications system 100 and/or node 110 assigns the even OFDM subcarriers (e.g., N/2 nonadjacent subcarriers) to a fast subscriber and shortens the symbol duration from T to T/2. This embodiment minimizes the impact to MAC scheduling and may further simplify not only the system design, but also amendments made to the 802.16e standard. For an embodiment ignoring the guard interval for intersymbol interference (“ISI”) mitigation, the communications system 100 and/or node 110 of an embodiment may communicates the same amount of data with either subcarrier spacing/symbol duration.

Further, the order of transmission by the communications system 100 and/or node 110 of an embodiment may be altered. In general, in band AMC mode, one band consists of 36 physically contiguous subcarriers. The total bandwidth of the band is comparable to coherent bandwidth of the channel. Therefore, frequency response roughly remains the same across the AMC band. In band AMC mode, a base station may ask a group of subscribers to feedback channel qualities of the several AMC bands. The channel quality may be signal to interference-plus-noise ratios (SINRs) of the desired AMC bands or the indexes of the desired AMC bands, which may be sorted by channel quality. The feedback may also be the delta change of SINR. As the frequency response of each subscriber's channel is usually different, the base station, according to multi-user diversity, can schedule different subscribers on different AMC bands so that each subscriber uses a distinct, favorable channel. For example, if subscriber A observes a high channel gain in AMC band 1 while subscriber B observes a high channel gain in AMC band 2, the base station can schedule subscriber A's data in band 1 and subscriber B's data in band 2 to maximize network throughput. In an embodiment, after the OFDM symbol duration is split to reduce ICI, the data of that AMC band should be placed in the original frequency region that was selected based on the feedback to maintain multi-user diversity. The transmission order of the data over the split symbols may be kept the same as that over the un-split symbols. In an embodiment, the transmission order may also relate to delay requirement of the data. For example, if subscriber A's data has a more stringent delay requirement than another subscriber's data, subscriber A's data transmission may be scheduled earlier in time.

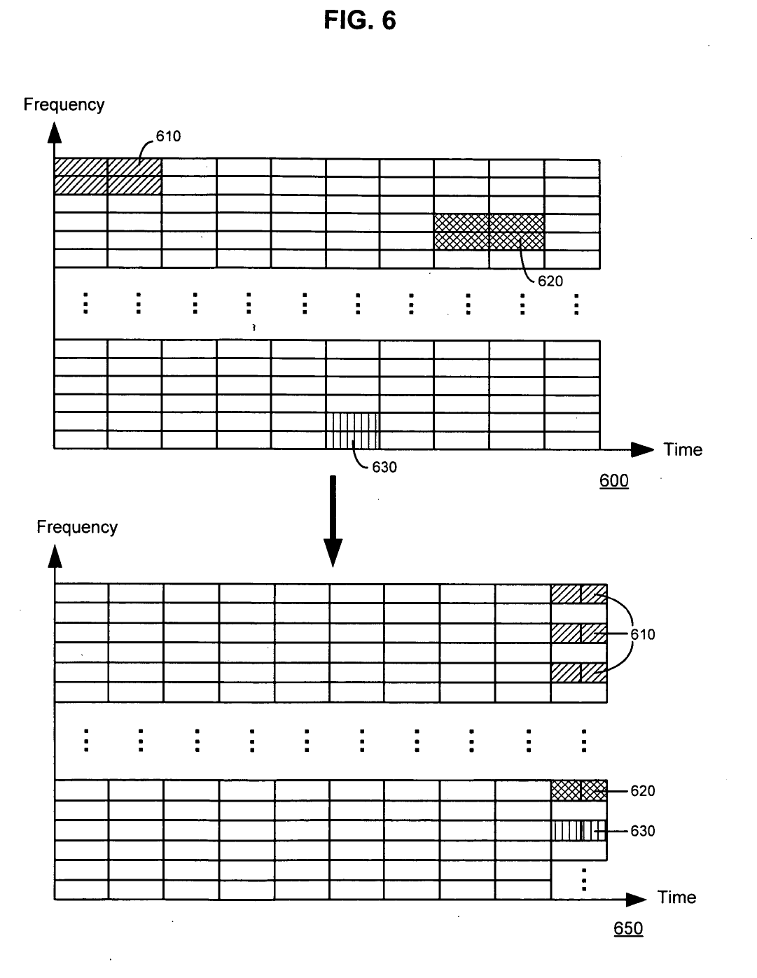

FIG. 6 illustrates the time-frequency location and grouping of multiple fast subscribers of an embodiment. The frequency-time zones of the fast subscriber symbols according to the 802.16e draft standard are usually scattered in each frame as illustrated in frame 600 by fast subscribers 610-630. In addition to altering the symbol duration and subcarrier spacing, the communications system 100 and/or node 110 of an embodiment further groups subscribers with like speeds in similar or adjacent frequency-time zones. For example, frame 650 of an embodiment illustrates fast subscribers 610-630 scheduled for transmission close to each other in time and frequency. For example, from an implementation viewpoint (e.g., receiver complexity), it is difficult for a receiver to separate split subcarriers and un-split subcarriers if the subcarriers intermix in one OFDM symbol, as the split and un-split subcarriers are not orthogonal and interfere each other. If the split subcarriers are grouped into one OFDM symbol as illustrated by frame 650, the demodulation of the split symbol that comprises split subcarriers is the same as that of an un-split symbol (e.g., one FFT for the whole symbol followed by QAM demapping per subcarrier).

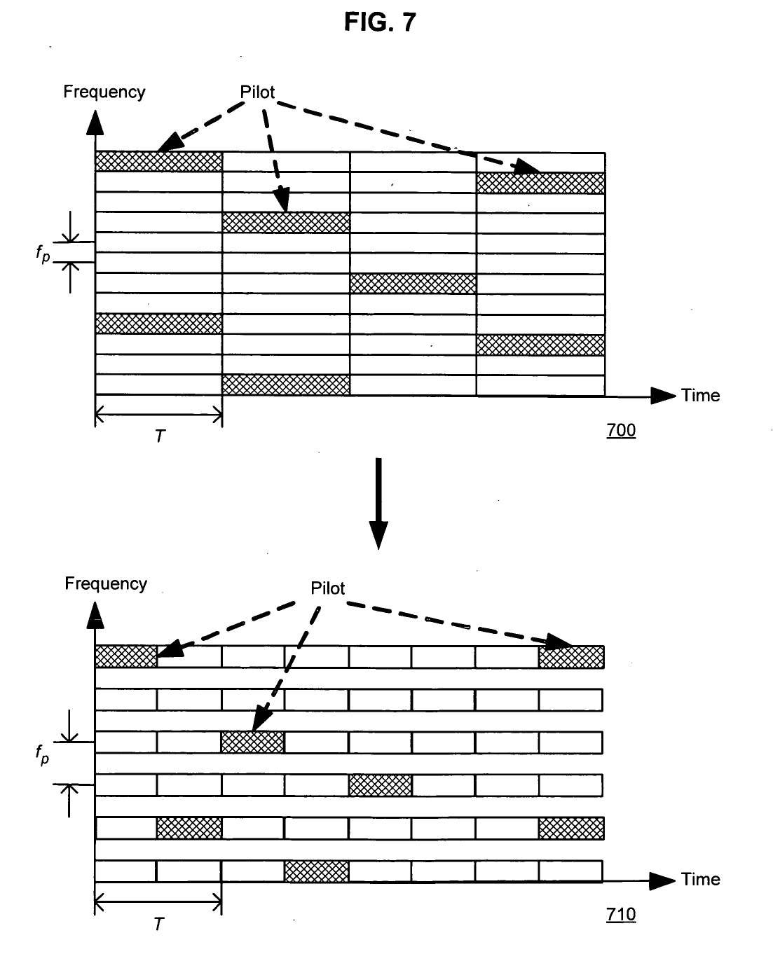

FIG. 7 illustrates the pilot location of an embodiment for frames 700 and 710. A pilot is a symbol sent on a subcarrier that is known at the receiver for channel estimation (according to 802.16e) or phase tracking (for receiver's phase locked loop according to 802.11). For example, the communications system 100 and/or node 110 of an embodiment may inform the subscribers of the subcarrier spacing change by specifying the splitting of symbol durations in a downlink frame header so that the subscribers know when and where the subcarrier and/or symbol splitting starts. In an alternate embodiment, communications system 100 and/or node 110 of an embodiment enables the subscriber to detect the symbol duration splitting dynamically or “on the fly” because the pilot locations for frames with and without subcarrier spacing and/or symbol duration splitting (e.g., frames 710 and 700 respectively) may be different but they are known by the subscriber. The subscriber can detect the pilots' location, detect the splitting, and demodulate the OFDM symbol accordingly. According to this embodiment, the communications system 100 and/or node 110 may split any OFDM symbol and the split symbols need not be adjacent.

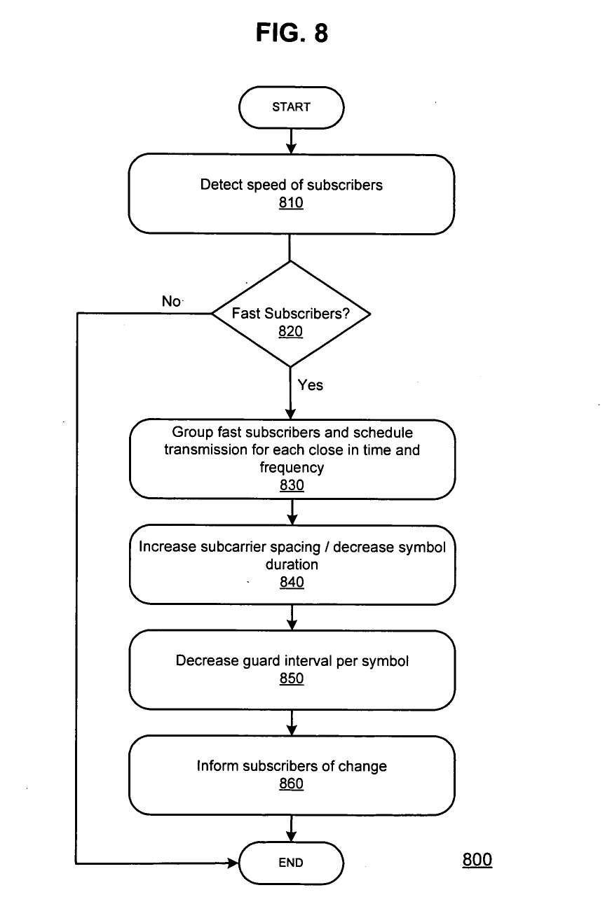

FIG. 8 illustrates one embodiment of a logic flow. FIG. 8 illustrates a logic flow 800 in accordance with one embodiment. At 810, the speed of a subscriber is detected. The subscriber speed can be detected by measuring the Doppler spread of the subscriber's OFDMA uplink signal, the delay spread of the OFDMA uplink signal, the intercarrier interference, or a combination thereof. The subscriber can thereafter be classified at 820 as a fast subscriber or a slow subscriber based on its speed compared to a threshold speed or speed relative to other subscribers. Thereafter for a fast subscriber, at 830 the subscriber is grouped with other subscribers of the same speed classification. For example, if the subscriber is classified as a fast subscriber, transmission to the fast subscriber can be scheduled closely (e.g., close or adjacent portions of the OFDM frame in time-frequency). For fast subscribers, at 840 the subcarrier spacing for the transmission is increased and the OFDM symbol duration is decreased. Further, at 850, the guard interval for each shortened OFDM symbol is itself shortened. As noted, the OFDM signal for the fast subscribers may have a shorter delay spread enabling the guard interval for each symbol thereof to be shortened. As a result, the total guard interval for transmission to a fast subscriber with shorter symbol length and increased subcarrier spacing would be substantially the same. Accordingly, the transmission to the fast subscriber would have substantially the same data rate as transmissions to slow subscribers. Finally, at 860 all subscribers are informed of the change to the subcarrier spacing and symbol duration. For example, a downlink frame header or pilot location may be used to inform the subscribers when and where the change starts.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

It is also worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

Some embodiments may be implemented using an architecture that may vary in accordance with any number of factors, such as desired computational rate, power levels, heat tolerances, processing cycle budget, input data rates, output data rates, memory resources, data bus speeds and other performance constraints. For example, an embodiment may be implemented using software executed by a general-purpose or special-purpose processor. In another example, an embodiment may be implemented as dedicated hardware. In yet another example, an embodiment may be implemented by any combination of programmed general-purpose computer components and custom hardware components. The embodiments are not limited in this context.

Various embodiments may be implemented using one or more hardware elements. In general, a hardware element may refer to any hardware structures arranged to perform certain operations. In one embodiment, for example, the hardware elements may include any analog or digital electrical or electronic elements fabricated on a substrate. The fabrication may be performed using silicon-based integrated circuit (IC) techniques, such as complementary metal oxide semiconductor (CMOS), bipolar, and bipolar CMOS (BiCMOS) techniques, for example. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. The embodiments are not limited in this context.

Various embodiments may be implemented using one or more software elements. In general, a software element may refer to any software structures arranged to perform certain operations. In one embodiment, for example, the software elements may include program instructions and/or data adapted for execution by a hardware element, such as a processor. Program instructions may include an organized list of commands comprising words, values or symbols arranged in a predetermined syntax, that when executed, may cause a processor to perform a corresponding set of operations. The software may be written or coded using a programming language. Examples of programming languages may include C, C++, BASIC, Perl, Matlab, Pascal, Visual BASIC, JAVA, ActiveX, assembly language, machine code, and so forth. The software may be stored using any type of computer-readable media or machine-readable media. Furthermore, the software may be stored on the media as source code or object code. The software may also be stored on the media as compressed and/or encrypted data. Examples of software may include any software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. The embodiments are not limited in this context.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Some embodiments may be implemented, for example, using a machine-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, and the like. The instructions may be implemented using any suitable high-level, low-level, object-oriented, visual, compiled and/or interpreted programming language, such as C, C++, Java, BASIC, Perl, Matlab, Pascal, Visual BASIC, assembly language, machine code, and so forth. The embodiments are not limited in this context.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

While certain features of the embodiments have been illustrated as described herein, many modifications, substitutions, changes and equivalents will now occur to those skilled in the art. It is therefore to be understood that the appended claims are intended to cover all such modifications and changes as fall within the true spirit of the embodiments.

1. An apparatus comprising a node to detect the speed of a subscriber to a communications system, the node to alter an orthogonal frequency division multiplexing subcarrier spacing and an orthogonal frequency division multiplexing symbol duration in response to the detection.

2. The apparatus of claim 1, the node to detect the speed of the subscriber based on at least one of a Doppler spread of a subscriber uplink signal, a delay spread of the subscriber uplink signal, or an intercarrier interference.

3. The apparatus of claim 2, the node to further group the subscriber with another subscriber according to their respective speeds.

4. The apparatus of claim 3, the node to further assign the subscriber and the other subscriber adjacent orthogonal frequency division multiplexing resources in the frequency and time domain.

5. The apparatus of claim 4, the node to further decrease an orthogonal frequency division multiplexing guard interval for the subscriber.

6. A communications system comprising:
a communications medium; and
a node to detect the speed of a subscriber to the communications system, the node to alter an orthogonal frequency division multiplexing subcarrier spacing and an orthogonal frequency division multiplexing symbol duration in response to the detection.

7. The communications system of claim 6, the node to detect the speed of the subscriber based on at least one of a Doppler spread of a subscriber uplink signal, a delay spread of the subscriber uplink signal, or an intercarrier interference.

8. The communications system of claim 7, the node to further group the subscriber with another subscriber according to their respective speeds.

9. The communications system of claim 8, the node to further assign the subscriber and the other subscriber adjacent orthogonal frequency division multiplexing resources in the frequency and time domain.

10. The communications system of claim 9, the node to further decrease an orthogonal frequency division multiplexing guard interval for the subscriber.

11. A method comprising:
detecting the speed of a subscriber to a communications system; and
altering an orthogonal frequency division multiplexing subcarrier spacing and an orthogonal frequency division multiplexing symbol duration to the subscriber upon detecting the speed of the subscriber.

12. The method of claim 11, detecting the speed of the subscriber further comprising at least one of detecting a Doppler spread of an orthogonal frequency division multiple access uplink signal, detecting a delay spread of the orthogonal frequency division multiple access uplink signal, or detecting the intercarrier interference.

13. The method of claim 12 further comprising grouping the subscriber with another subscriber according to their respective speeds.

14. The method of claim 13, further comprising assigning the subscriber and the other subscriber adjacent orthogonal frequency division multiplexing resources in the frequency and time domain.

15. The method of claim 14 further comprising decreasing an orthogonal frequency division multiplexing guard interval for the subscriber.

16. An article comprising a machine-readable storage medium containing instructions that if executed enable a communications system to:
detect the speed of a subscriber to the communications system, and
alter an orthogonal frequency division multiplexing subcarrier spacing and an orthogonal frequency division multiplexing symbol duration in response to the detection.

17. The article of claim 16 further comprising instructions that if executed enable the communications system to detect the speed of the subscriber based on at least one of a Doppler spread of a subscriber uplink signal, a delay spread of the subscriber uplink signal, or an intercarrier interference.

18. The article of claim 17 further comprising instructions that if executed enable the communications system to group the subscriber with another subscriber according to their respective speeds.

19. The article of claim 18 further comprising instructions that if executed enable the communications system to assign the subscriber and the other subscriber adjacent orthogonal frequency division multiplexing resources in the frequency and time domain.

20. The article of claim 19 further comprising instructions that if executed enable the communications system to decrease an orthogonal frequency division multiplexing guard interval for the subscriber.
